(19) United States
(12) Patent Application Publication
(10) Pub. No.: US 2014/0217816 A1
(43) Pub. Date: Aug. 7, 2014

(54) MOBILE TERMINAL CHARGING SYSTEM AND MOBILE TERMINAL CHARGING METHOD

(71) Applicant: Hiroki Okada, Toyota-shi (JP)

(72) Inventor: Hiroki Okada, Toyota-shi (JP)

(73) Assignee: TOYOTA JIDOSHA KABUSHIKI KAISHA, Toyota-shi, Aichi-ken (JP)

(21) Appl. No.: 14/240,890

(22) PCT Filed: Aug. 28, 2012
(86) PCT No.: PCT/IB2012/001646

§ 371 Date: Feb. 25, 2014

(30) Foreign Application Priority Data
Aug. 29, 2011 (JP) 2011-185971

(51) Int. Cl. B60R 16/03

(52) U.S. Cl. CPC B60R 16/03
USPC 307/10.1

(57) ABSTRACT

A mobile terminal charging system includes: a wireless power supply device that is provided inside a vehicle cabin and that is configured to perform a charging operation for charging a mobile terminal; and a control device that controls the wireless power supply device, wherein, when wireless communication is carried out between an in-vehicle communication device and an electronic key inside the vehicle cabin in a situation that the charging operation is being performed by the wireless power supply device, the control device temporarily suppresses the charging operation performed by the wireless power supply device.

### BACKGROUND OF THE INVENTION

1. Field of the Invention

The invention relates to a mobile terminal charging system that includes a wireless power supply device that carries out charging operation for charging a mobile terminal and a mobile terminal charging method that uses the wireless power supply device.

2. Description of Related Art

There is conventionally known a contactless charging system that charges a mobile terminal in a contactless manner (for example, see Japanese Patent Application. Publication No. 2003-18758 (JP 2003-18758 A)).

In addition, there is known a mobile terminal that includes a secondary coil for carrying out power transfer (contactless power transfer) utilizing electromagnetic induction to or from a primary coil of a primary device (wireless power supply device) and a wireless communication antenna for wirelessly carrying out information communication (for example, see Japanese Patent Application Publication No. 2008-206297 (JP 2008-206297 A)). The mobile terminal is configured to transmit information that requests the primary device to stop contactless power transfer in advance of start of information communication with another terminal through the wireless communication antenna.

However, in the case where the wireless power supply device is mounted in a vehicle cabin, when wireless communication is carried out between an in-vehicle communication device and an electronic key in the vehicle cabin while the mobile terminal is being charged, a communication error may occur because of radio wave interference. That is, a radio wave generated from the wireless power supply device that is charging the mobile terminal may interfere with wireless communication between the in-vehicle communication device and the electronic key in the vehicle cabin.

### SUMMARY OF THE INVENTION

The invention provides a mobile terminal charging system and mobile terminal charging method that are able to suppress interference with wireless communication between an in-vehicle communication device and an electronic key due to a charging operation of a wireless power supply device.

A first aspect of the invention provides a mobile terminal charging system. The mobile terminal charging system includes: a wireless power supply device that is provided inside a vehicle cabin and that is configured to perform a charging operation for charging a mobile terminal; and a control device that controls the wireless power supply device, wherein, when wireless communication is carried out between an in-vehicle communication device and an electronic key inside the vehicle cabin in a situation that the charging operation is being performed by the wireless power supply device, the control device temporarily suppresses the charging operation performed by the wireless power supply device.

A second aspect of the invention provides a mobile terminal charging method. The mobile terminal charging method includes: controlling a wireless power supply device, provided inside the vehicle cabin, to perform a charging operation for charging a mobile terminal; and when wireless communication is carried out between an in-vehicle communication device and an electronic key inside a vehicle cabin in a situation that the charging operation is being performed by the wireless power supply device, temporarily suppressing the charging operation performed by the wireless power supply device.

With the above configurations, it is possible to suppress interference with wireless communication between an in-vehicle communication device and an electronic key due to a charging operation performed by a wireless power supply device.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view that shows a main part of an in-vehicle mobile terminal charging system 1 according to an embodiment of the invention together with associated components;

FIG. 2 is a cross-sectional view of a main part that shows an example of the structure of a wireless power supply device 70;

FIG. 3 is a flowchart that shows an example of main processes implemented by a collating ECU 10 of the in-vehicle mobile terminal charging system 1 according to the embodiment;

FIG. 4 is a timing chart corresponding to the main processes shown in FIG. 3;

FIG. 5 is a view that shows an example of a mode in which a power supply line 75 is connected to the wireless power supply device 70;

FIG. 6 is a view that shows an example of a method of generating a charge stop signal/charge resume signal;

FIG. 7 is a waveform chart that shows various statuses associated with FIG. 6;

FIG. 8 is a view that shows another example of a method of generating a charge stop signal/charge resume signal;

FIG. 9 is a flowchart that shows an example of main processes executed by a wireless power supply control unit 72 of the wireless power supply device 70; and

FIG. 10 is a timing chart corresponding to the processes shown in FIG. 9.

### DETAILED DESCRIPTION OF EMBODIMENTS

Hereinafter, embodiments of the invention will be described with reference to the accompanying drawings.

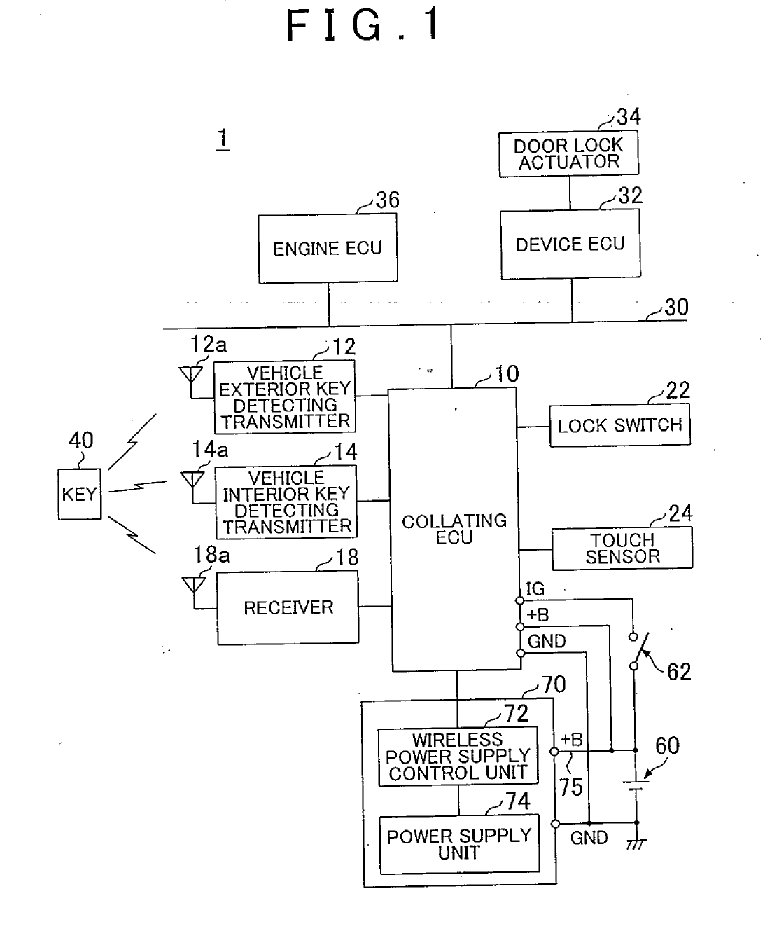

FIG. 1 is a configuration view that shows a main part of an in-vehicle mobile terminal charging system 1 according to an embodiment of the invention together with associated components.

The in-vehicle mobile terminal charging system 1 includes a collating ECU 10 as a main component. The collating ECU 10 controls a smart key system. The collating ECU 10 is formed as a microcomputer that is formed of a CPU, a ROM, a RAM, and the like, that are connected to one another via a bus (not shown). The ROM stores various programs executed by the CPU.

A vehicle exterior key detecting transmitter 12 is connected to the collating ECU 10. The vehicle exterior key detecting transmitter 12 forms a detection area for detecting an electronic key 40 outside a vehicle cabin. The'vehicle exterior key detecting transmitter 12 includes a vehicle exterior key detecting antenna 12a . The vehicle exterior key detecting transmitter 12 transmits a request signal to an area outside of the vehicle cabin via the vehicle exterior key detecting antenna 12a . By so doing, the vehicle exterior key detecting transmitter 12 forms the detection area for detecting the electronic key 40 outside the vehicle cabin. Note that a plurality of the vehicle exterior key detecting transmitters 12 (and the vehicle exterior key detecting antennas 12a ) may be provided, and may be, for example, respectively embedded in door outside knobs of doors of the vehicle one by one.

A vehicle interior key detecting transmitter 14 is connected to the collating ECU 10. The vehicle interior key detecting transmitter 14 forms a detection area for detecting the electronic key 40 inside the vehicle cabin. The vehicle interior key detecting transmitter 14 includes a vehicle interior key detecting antenna 14a . The vehicle interior key detecting transmitter 14 transmits a request signal into the vehicle cabin via the vehicle interior key detecting antenna 14a . By so doing, the vehicle interior key detecting transmitter 14 forms the detection area for detecting the electronic key 40 inside the vehicle cabin. For example, the frequency of the request signal may be 125 kHz or 134 kHz. Note that a plurality of the vehicle interior key detecting transmitters 14 (and the vehicle interior key detecting antennas 14a ) may be provided, and the three vehicle interior key detecting transmitters 14 (and vehicle interior key detecting antennas 14a )may be, for example, provided in correspondence with a front seat space, rear seat space and luggage space of the vehicle.

A receiver 18 is connected to the collating ECU 10. The receiver 18 receives a response signal (transmission radio wave) from the electronic key 40. The receiver 18 is arranged at a position at which the receiver 18 is able to receive a response signal transmitted from the electronic key 40 located in the detection area of the vehicle exterior key detecting antenna 12a and a response signal transmitted from the electronic key 40 located in the detection area of the vehicle interior key detecting antenna 14a , and may be, for example, arranged on the side of the vehicle rear seat. An additional receiver 18 may be additionally arranged in the luggage space. The number of the receivers 18 and the arrangement position of each receiver 18 may be selected arbitrarily. When the receiver 18 receives a response signal from the electronic key 40, the response signal received from the electronic key 40 is subjected to a predetermined process, such as amplifying and decoding, and then the decoded response signal is output to the collating ECU 10. The collating ECU 10 compares a collation code included in the received response signal with a collation code stored in a predetermined memory (not shown), and, when these collation codes coincide with each other, outputs an authentication result that the electronic key 40 is an authorized key (an authentication result indicating that the electronic key 40 is authenticated).

The electronic key 40 includes a transceiver (transponder) and a transceiver antenna. The transponder carries out bidirectional communication using a weak radio wave with a vehicle-side transceiver (the vehicle exterior key detecting transmitter 12, the vehicle interior key detecting transmitter 14, the receiver 18, and the like). A memory that stores a given valid collation code (ID code) is embedded in the electronic key 40. Note that the electronic key 40 may incorporate a mechanical key by which a user is able to manually lock and unlock a door of the vehicle. Alternatively, the electronic key 40 may be independent of a mechanical key.

When the electronic key 40 receives a request signal transmitted through the vehicle exterior key detecting antenna 12a as described above, the electronic key 40 transmits a response signal appropriate for the request signal. The response signal may include a code, indicating a response to the vehicle exterior key detecting antenna 12a , together with a collation code. In addition, when the electronic key 40 receives a request signal transmitted through the vehicle interior key detecting antenna 14a as described above, the electronic key 40 transmits a response signal appropriate for the request signal. The frequency of the response signal may be, for example, 314 MHz. The response signal may include a code, indicating a response to the vehicle interior key detecting antenna 14a , together with a collation code.

A lock switch 22 and a touch sensor 24 are connected to the collating ECU 10. The lock switch 22 turns on or off in response to a lock operation for locking the door. The touch sensor 24 is used to detect a touch operation to the door outside knob. The lock switch 22 and the touch sensor 24 are provided near the door outside knob. The touch sensor 24 may be arranged so as to detect a touch operation to the back side of the door outside knob.

A device ECU 32 is connected to the collating ECU 10 via a bidirectional multiplex communication line 30. A door lock actuator 34 is connected to the device ECU 32. The door lock actuator 34 drives a door lock mechanism. The door lock actuator 34 switches the door lock mechanism between a door locked state and a door unlocked state on the basis of a control signal from the device ECU 32. In addition, an engine ECU 36 is connected to the collating ECU 10 via the bidirectional multiplex communication line 30.

Here, smart communication at the time when a passenger gets into the vehicle will be simply and generally described. The collating ECU 10 collates the collation code on the basis of a response signal transmitted from the electronic key 40 in response to a request signal from the vehicle exterior key detecting transmitter 12, and permits unlocking of the door when collation is successful (i.e., when the electronic key. 40 is authenticated). In this unlocking permitted state, when a touch operation to the back side of the door outside knob has been detected, the device ECU 32 unlocks the door through the door lock actuator 34. Subsequently, the collating ECU 10 collates the collation code on the basis of a response signal transmitted from the electronic key 40 in response to a request signal from the vehicle interior key detecting transmitter 14, and permits a start of an engine when collation is successful. In this engine start permitted state, when a brake pedal is depressed and an engine start switch is operated, the engine ECU 36 starts the engine. Note that, at this time, an ignition switch 62 is turned on.

A wireless power supply device 70 is connected to the collating ECU 10. The collating ECU 10 and the wireless power supply device 70 may be connected to each other in any mode unless otherwise specified, and may be, for example, connected in a wireless or wired manner or in a combination of them, and may be connected directly or indirectly.

The wireless power supply device 70 is connected to a power supply line 75 and a GND line. A voltage +B is applied to the power supply line 75. The wireless power supply device 70 operates on the basis of the voltage +B applied through the power supply line 75. Note that the wireless power supply device 70 may be connected to the power supply line 75 and the GND line via the collating ECU 10 or another ECU.

The wireless power supply device 70 charges a mobile terminal with electric power from an in-vehicle battery 60 by utilizing electromagnetic induction of coils. The wireless power supply device 70 includes a wireless power supply control unit 72 and a power supply unit 74. The wireless power supply control unit 72 mainly controls a charging operation for charging the mobile terminal through the power supply unit 74. The power supply unit 74 includes a contactless power transfer coil (primary coil). A power transmission frequency used in the wireless power supply device 70 may, for example, range from 100 to 200 kHz.

Note that part or whole of the functions of the wireless power supply control unit 72 may be implemented by the collating ECU 10. Alternatively, part of the functions of the collating ECU 10 may be implemented by the wireless power supply control unit 72. In addition, part or whole of the functions of the wireless power supply control unit 72 may be implemented by the collating ECU 10 and another ECU in cooperation or may be implemented by another ECU other than the collating ECU 10.

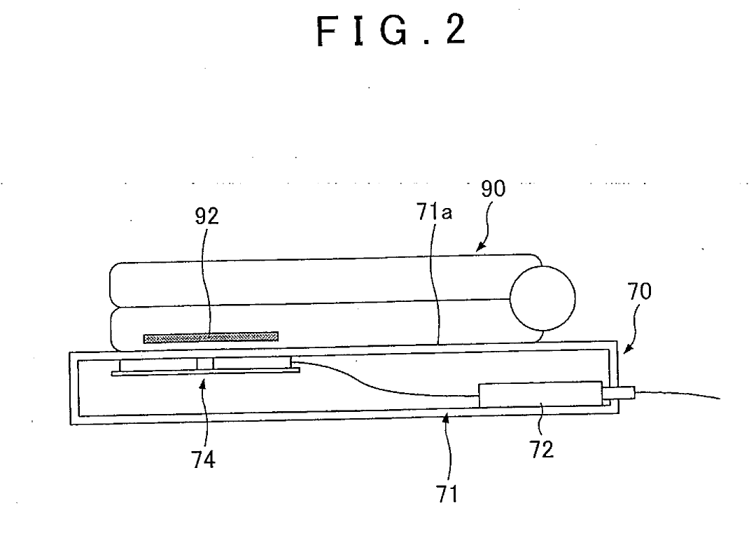

FIG. 2 is a cross-sectional view that shows an example of the structure of the wireless power supply device 70. FIG. 2 also shows a mobile terminal 90 placed on the wireless power supply device 70.

The wireless power supply device 70 may be incorporated in a cradle on which a mobile terminal is placed. The wireless power supply device 70 includes a casing 71 that accommodates components (the power supply unit 74, and the like) inside. The mobile terminal 90 is placed (set) on a surface 71a of the casing 71. The power supply unit 74 that includes the contactless power transfer coil is provided on the back side of the surface 71a of the casing 71.

When the mobile terminal 90 is placed on the wireless power supply device 70, the contactless power transfer coil 92 of the mobile terminal 90 is arranged at a position at which the contactless power transfer coil 92 faces the power supply unit 74. Then, when alternating current having a predetermined frequency is supplied to the power supply unit 74, alternating current is generated in the contactless power transfer coil 92 of the mobile terminal 90 through electromagnetic induction, so a battery (not shown) of the mobile terminal 90 is charged. In this way, the mobile terminal 90 is charged in a contactless (wireless) manner that does not require wire connection or contact connection.

The wireless power supply device 70 is provided in the vehicle cabin. The wireless power supply device 70 may be, for example, provided at an instrument panel. Note that the mobile terminal 90 may be selected arbitrarily as long as the mobile terminal 90 is configured to be charged by the wireless power supply device 70, and may be, for example, a cellular phone, including a smart phone, and a tablet.

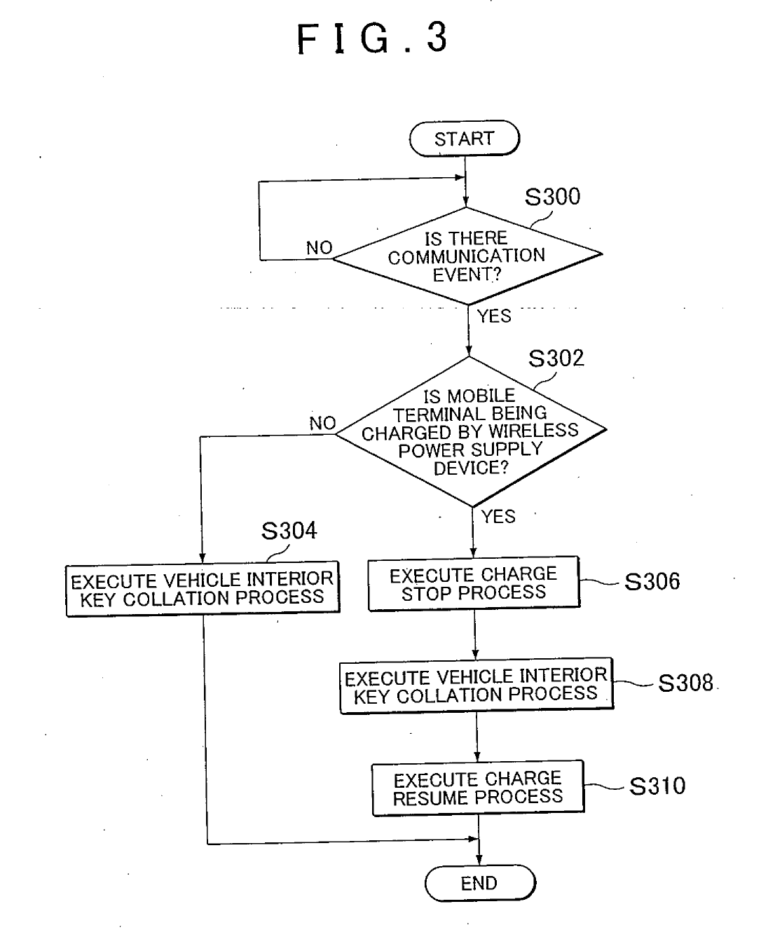

FIG. 3 is a flowchart that shows an example of main processes implemented by the collating ECU 10 of the in-vehicle mobile terminal charging system 1 according to the present embodiment. The processing routine shown in FIG. 3 may be, for example, executed at predetermined intervals when the ignition switch 62 is turned on.

In step 300, it is determined whether there occurs a communication event for vehicle interior key collation process. That is, it is determined whether it is the timing at which the vehicle interior key collation process is executed. The condition for executing the vehicle interior key collation process may be selected. The vehicle interior key collation process may be, for example, executed at predetermined time intervals or at intervals of predetermined travel distance. In addition, the vehicle interior key collation process may be, for example, executed when a door open/close operation has been detected while the ignition switch 62 is in an on state or may be executed at predetermined time intervals during a stop of the vehicle. Alternatively, the vehicle interior key collation process may be executed when a transition from a vehicle travelling state to a vehicle stop state has been detected, or may be executed when a window open state or a window open operation has been detected in a vehicle stop state. Further, the vehicle interior key collation process may be executed when a vehicle low-speed travelling state has continued for a predetermined period of time or longer, or when an accumulated period of time of the vehicle low-speed travelling state is longer than or equal to the predetermined period of time. When there occurs the communication event for the vehicle interior key collation process, the process proceeds to step 302.

In step 302, it is determined whether a charging operation for charging the mobile terminal 90 is being performed in the wireless power supply device 70. That is, it is determined whether power is being supplied to the power supply unit 74. Note that the state of the wireless power supply device 70 (whether it is charging) may be determined on the basis of information from the wireless power supply control unit 72 of the wireless power supply device 70. When the charging operation for charging the mobile terminal 90 is being performed in the wireless power supply device 70, the process proceeds to step 306. When the charging operation for charging the mobile terminal 90 is not being performed in the wireless power supply device 70, the process proceeds to step 304.

In step 304, the vehicle interior key collation process is executed. Specifically, the collating ECU 10 transmits a request signal through the vehicle interior key detecting transmitter 14 and the vehicle interior key detecting antenna 14a . At this time, when the electronic key 40 is present inside the vehicle cabin, the electronic key 40 transmits a response signal in response to the request signal, and the response signal is received by the receiver 18. When the receiver 18 receives the response signal from the electronic key 40, a collation code included in the response signal is decoded, and the collation code included in the response signal is supplied to the collating ECU 10. On the other hand, when the electronic key 40 is not present inside the vehicle cabin, the electronic key 40 does not respond to the request signal, and no response signal from the electronic key 40 is received by the receiver 18. When the collating ECU 10 receives the collation code included in the response signal, the collating ECU 10 compares the collation code included in the response signal with the collation code stored in the predetermined memory. When these collation codes coincide with each other, it is determined that collation is successful (OK) (that is, it is determined that the authorized electronic key 40 is present inside the vehicle cabin), and then the process in response to occurrence of the current communication event is ended.

On the other hand, when no response signal from the electronic key 40 is received by the receiver 18 or when the response signal from the electronic key 40 is received by the receiver 18 but the collation codes do not coincide with each other, it is determined that collation is unsuccessful (NG), and a request signal may be transmitted again (that is, key collation process is retried) after a lapse of a predetermined period of time (for example, three seconds). After retry of the key collation process, when collation is successful., the process in response to occurrence of the current communication event is ended. Note that, even when collation is still unsuccessful after the key collation process is retried a predetermined number of times, a warning is issued against carrying the electronic key 40 outside the vehicle.

In step 306, a charge stop process for stopping the charging operation for charging the mobile terminal 90 by the wireless power supply device 70 is executed. This process may be implemented by for example, transmitting a charge stop signal to the wireless power supply control unit 72 of the wireless power supply device 70 or temporarily interrupting the power supply line 75 (for example, by a switch, a relay, or the like) that connects the in-vehicle battery 60 to the wireless power supply device 70. In the former case, the wireless power supply control unit 72 stops the active charging operation in response to the charge stop signal. In the latter case, power supplied to the wireless power supply device 70 is interrupted, so the charging operation is forcibly stopped. When the charge stop process ends, the process proceeds to step 308.

In step 308, the vehicle interior key collation process is executed. Specifically, as in the case of step 304, the collating ECU 10 transmits a request signal through the vehicle interior key detecting transmitter 14 and the vehicle interior key detecting antenna 14a . When the collating ECU 10 receives the collation code included in the response signal, the collating ECU 10 compares the collation code included in the response signal with the collation code stored in the predetermined memory. When these collation codes coincide with each other, it is determined that collation is successful (OK) (that is, it is determined that the authorized electronic key 40 is present inside the vehicle cabin). Then, the vehicle interior key collation process is ended, and the process proceeds to step 310. On the other hand, when no response signal from the electronic key 40 is received by the receiver 18 or when the response signal from the electronic key 40 is received by the receiver 18 but the collation codes do not coincide with each other, it is determined that collation is unsuccessful (NG), and a request signal may be transmitted again after a lapse of a predetermined period of time (for example, three seconds). After retry of the key collation process, when collation is successful, the vehicle interior key collation process is ended, and the process proceeds to step 310. Note that, even when collation is still unsuccessful after the key collation process is retried a predetermined number of times, the process may proceed to step 310 and a warning may be issued against carrying the electronic key 40 outside the vehicle.

In step 310, a charge resume process for resuming (permitting) the charging operation for charging the mobile terminal 90 by the wireless power supply device 70, stopped in step 306, is executed. This process may be implemented by, for example, transmitting a charge resume signal to the wireless power supply control unit 72 of the wireless power supply device 70 or allowing conduction of the power supply line 75 from the in-vehicle battery 60 to the wireless power supply device 70 (changing from an interrupted state to a conductive state). In the former case, the wireless power supply control unit 72 resumes the stopped charging operation in response to the charge resume signal. In the latter case, power supplied to the wireless power supply device 70 is restored, so the charging operation is resumed. When the charge resume process ends, the process in response to occurrence of the current communication event is ended.

Note that, in the process shown in FIG. 3, the collating ECU 10 determines in step 302 whether the charging operation for charging the mobile terminal 90 is being performed in the wireless power supply device 70. However, the collating ECU 10 does not need to determine whether the charging operation for charging the mobile terminal 90 is being performed in the wireless power supply device 70. In this case, when determination of step 300 is affirmative, the process of step 302 is skipped, and the process proceeds to step 306. Then, the wireless power supply device 70 just needs to respond to the charge stop signal generated in step 306 only during charging.

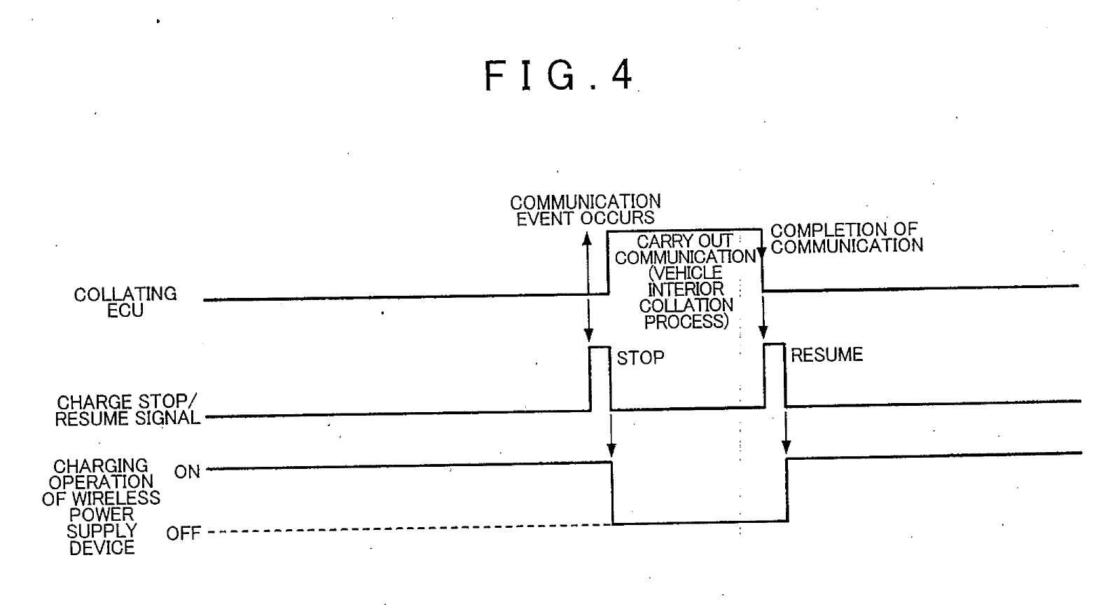

FIG. 4 is a timing chart corresponding to the processes shown in FIG. 3. FIG. 4 shows, from the upper side, the status of the collating ECU 10 (the execution status of the vehicle interior key collation process), the status of the charge stop signal/charge resume signal and the status of the charging operation for charging the mobile terminal 90 by the wireless power supply device 70 in time sequence.

As shown in FIG. 4, when there occurs a communication event, the charge stop signal is generated, and, in response to this, the charging operation for charging the mobile terminal 90 by the wireless power supply device 70 is set to an off state. Then, while the charging operation for charging the mobile terminal 90 by the wireless power supply device 70 is in an off state, communication (vehicle interior key collation process) is carried out. In synchronization with completion of communication, the charge resume signal is generated, and, in response to this, the charging operation for charging the mobile terminal 90 by the wireless power supply device 70 is set to an on state.

During the charging operation, a radio wave (noise) occurs from the wireless power supply device 70, and the radio wave may interfere with wireless communication for the vehicle interior key collation process. For example, when the frequency of a radio wave that occurs from the wireless power supply device 70 during the charging operation is 150 kHz, the radio wave may mainly interfere with a request signal transmitted from the vehicle interior key detecting antenna 14a.

In contrast to this, with the processes shown in FIG. 3, when wireless communication is carried out between the vehicle interior key detecting transmitter 14 and receiver 18 and the electronic key 40 inside the vehicle cabin in a situation that the charging operation for charging the mobile terminal 90 is being performed by the wireless power supply device 70, the charging operation for charging the mobile terminal 90 by the wireless power supply device 70 is temporarily stopped. That is, at the time of carrying out wireless communication for the vehicle interior key collation process, when the charging operation for charging the mobile terminal 90 is being performed by the wireless power supply device 70, the charging operation is temporarily stopped. By so doing, it is possible to suppress a communication failure (that is, radio wave interference in wireless communication for the vehicle interior key collation process, or the like) due to a radio wave (noise) generated by the wireless power supply device 70 during the charging operation.

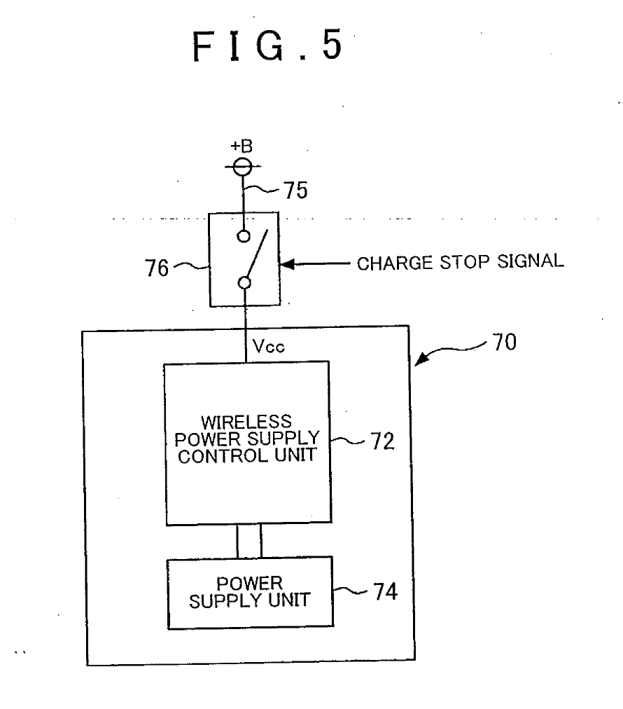

FIG. 5 is a view that shows an example of a mode in which the power supply line 75 is connected to the wireless power supply device 70.

A switch (switch box) 76 may be provided in the power supply line 75 connected to the wireless power supply device 70 as shown in FIG. 5. The switch 76 enters an open state in accordance with the charge stop signal from the collating ECU 10. By so doing, the power supply line 75 from the in-vehicle battery 60 to the wireless power supply device 70 is interrupted (power supplied to the wireless power supply device 70 is cut), and the charging operation performed by the wireless power supply device 70 is stopped. On the other hand, the switch 76 enters a closed state in accordance with the charge stop signal from the collating. ECU 10. By so doing, conduction of the power supply line 75 from the in-vehicle battery 60 to the wireless power supply device 70 is allowed, so it is possible to perform the charging operation by the wireless power supply device 70. Note that the switch 76 may be another switch, such as a relay, instead of the switch box.

According to the configuration shown in FIG. 5, the switch 76 provided between the wireless power supply,device 70 and a power supply makes it possible to stop the charging operation at the time of wireless communication for the vehicle interior key collation process, without the need for a special function for stopping and resuming the charging operation on the wireless power supply device 70. That is, without requiring the wireless power supply device 70 for a special function, a source that generates noise that interferes with wireless communication for the vehicle interior key collation process is stopped. Thus, it is possible to establish further reliable communication. Thus, for example, the wireless power supply device 70 may be a general product.

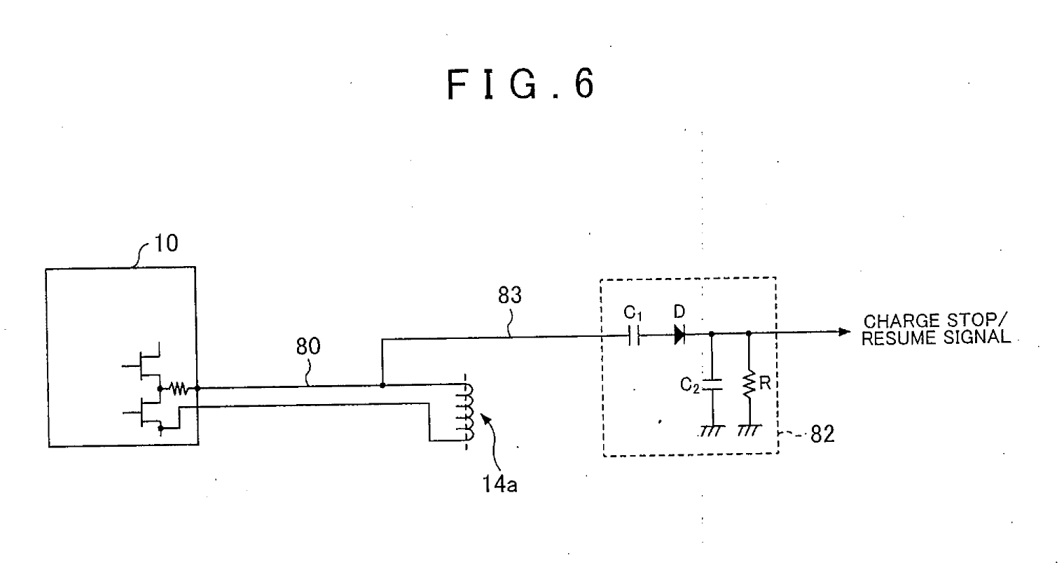

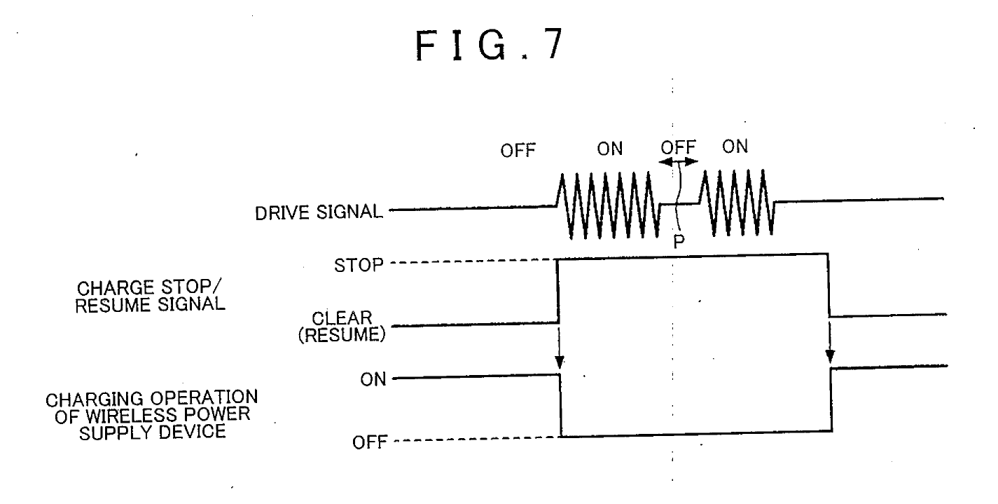

FIG. 6 is a view that shows an example of a method of generating a charge stop signal/charge resume signal. FIG. 7 is a waveform chart that shows various statuses associated with FIG. 6. FIG. 7 shows, from the upper side, the status of a drive signal to the vehicle interior key detecting antenna 14a , the status of the charge stop signal/charge resume signal, the status of the charging operation for charging the mobile terminal 90 by the wireless power supply device 70 in time sequence.

In the example shown in FIG. 6, a drive signal for driving the vehicle interior key detecting antenna 14a , generated during the vehicle interior key collation process (during wireless communication), is extracted to generate the charge stop signal. The charge stop signal is generated by converting the drive signal for the vehicle interior key detecting antenna 14a . Specifically, a signal generating circuit 82 is directly connected by a line 83 to a drive line 80 that drives the vehicle interior key detecting antenna 14a . The signal generating circuit 82 includes a capacitor C1 for cutting direct current and a detector diode in addition, a capacitor C2 and a resistor R that serve as a smoothing circuit are connected in parallel on the downstream side of the detector diode D. By so doing, the positive portion of the waveform extracted by the detector diode D is smoothed by charging and discharging the capacitor C2 such that the drive signal (alternating-current signal) for the vehicle interior key detecting antenna 14a is converted into the charge stop signal. Here, the capacitor C1 may be selected so that influence on the vehicle interior key detecting antenna 14a (influence on impedance) is reduced. In addition, the capacitor C2 and the resistor R may be selected to have a time constant such that a signal is not inverted during a off period (period P in FIG. 7). Note that, in the drive signal, there is a period in which the amplitude is zero (zero amplitude period) for modulation. The off period may correspond to a zero amplitude period in the drive signal.

According to the example shown in FIG. 6, as shown in FIG. 7, when a communication event occurs, a drive signal to the vehicle interior key detecting antenna 14a is generated, and, accordingly, the charge stop signal enters an on state (High) (the Charge stop signal is generated). In response to the charge stop signal, the charging operation for charging the mobile terminal 90 by the wireless power supply device 70 is set to an off state. Then, while the charging operation for charging the mobile terminal 90 by the wireless power supply device 70 is in an off state, communication (vehicle interior key collation process) is carried out. When the communication is completed (in this case, when transmission of a request signal from the vehicle interior key detecting antenna 14a is completed), the charge stop signal enters an off state (Low) (the charge resume signal is generated) as the drive signal to the vehicle interior key detecting antenna 14a is stopped, and, in response to this, the charging operation for charging the mobile terminal 90 by the wireless power supply device 70 is set to an on state.

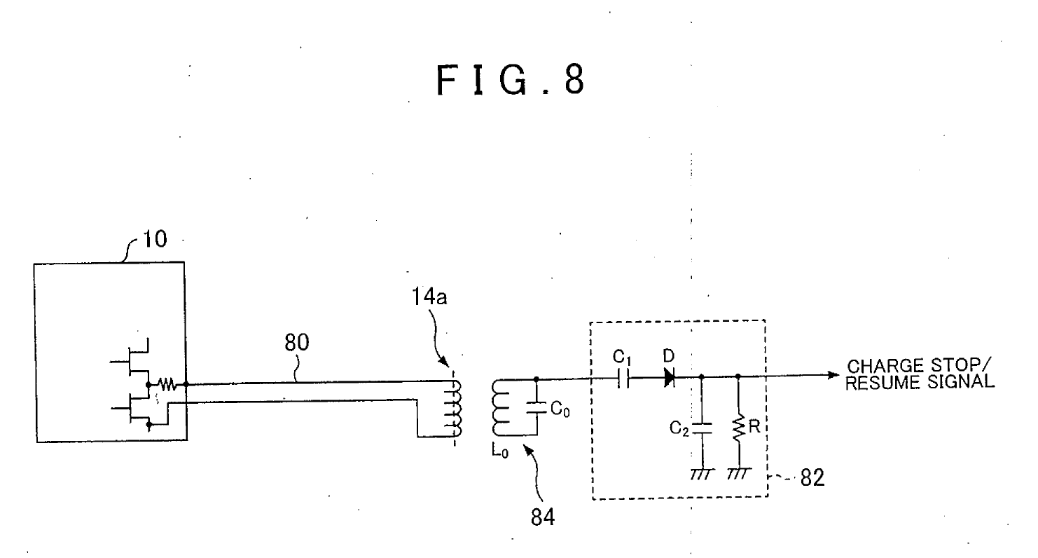

FIG. 8 is a view that shows another example of a method of generating a charge stop signal/charge resume signal.

In the example shown in FIG. 8, as in the case of the example shown in FIG. 6, a drive signal to the vehicle interior key detecting antenna 14a , generated during the vehicle interior key collation process (during wireless communication) extracted to generate the charge stop signal. Specifically, the signal generating circuit 82 is directly connected via an LC resonance circuit unit 84 to the drive line 80 for driving the vehicle interior key detecting antenna 14a . The LC resonance circuit unit 84 has a resonance frequency corresponding to the frequency of the drive signal, and is arranged in proximity to the vehicle interior key detecting antenna 14a . When the drive signal flows through the coil that constitutes the vehicle interior key detecting antenna 14a , an alternating-current signal corresponding to the drive signal is generated by the LC resonance circuit unit 84. As in the case of the example shown in FIG. 6, the positive portion of the waveform extracted by the detector diode D is smoothed by charging and discharging the capacitor C2 such that the alternating-current signal is converted into the charge stop signal.

In this way, with the method of generating a charge stop signal/charge resume signal shown in FIG. 6 and FIG. 8, it is not required to output a new instruction signal as the charge stop signal. That is, by detecting and smoothing the drive signal (125 kHz or 134 kHz) for driving the vehicle interior key detecting antenna 14a , a charge stop signal/charge resume signal is generated. By so doing, it is possible to control the charging operation for charging the mobile terminal 90 by the wireless power supply device 70.

Note that, in the example shown in FIG. 6 and FIG. 8, when the capacitor C2 has a large capacitance, the initial timing at which a signal is switched (the timing at which a charge stop signal is generated) may slightly delay from the timing at which the drive signal to the vehicle interior key detecting antenna 14a is generated. However, if the result of the first vehicle interior key collation process is NG because of the delay, the key collation process is retried as described above to thereby make it possible to establish communication for the second time.

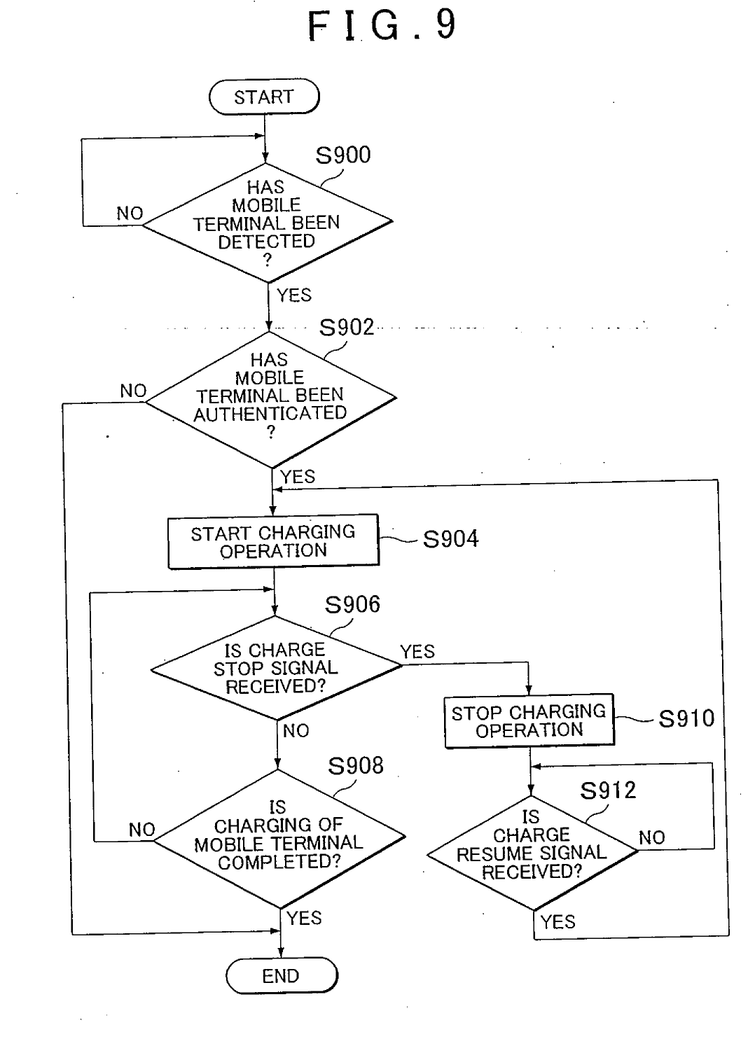

FIG. 9 is a flowchart that shows an example of main processes executed by the wireless power supply control unit 72 of the wireless power supply device 70. The processing routine shown in FIG. 9 may be, for example, executed at predetermined intervals when the ignition switch 62 is turned on.

In step 900, the process of detecting a mobile terminal is executed. Specifically, it is determined whether a mobile terminal is placed in a chargeable state (for example, at a chargeable position) on the wireless power supply device 70. When the mobile terminal is placed, the process proceeds to step 902; otherwise, determination of step 900 is carried out again after the predetermined interval.

In step 902, the process of authenticating the mobile terminal is executed. The authentication process may be executed on the basis of information obtained through wireless communication between the wireless power supply device 70 and the mobile terminal. For example, the authentication process may be implemented by communication of unique code information (ID code) and collation of the code information. When the collation is successful (when the mobile terminal is authenticated), the process proceeds to step 904. When the collation is unsuccessful, the process ends. Note that, when the collation is unsuccessful, information about the unsuccessful collation may be provided to a user in order to prompt the user to, for example, reset the mobile terminal.

In step 904, the charging operation is started. That is, charging of the mobile terminal is started by the power supply unit 74.

In step 906, it is determined whether the charge stop signal is input from the collating ECU 10. Note that it is possible to generate the charge stop signal in various modes as described above. In addition, the charge stop signal may be input to the wireless power supply device 70 in various modes. For example, the charge stop signal may be input from the collating ECU 10 via a communication line (which may be an exclusive line or may be a communication line, such as a CAN and a LIN). The charge stop signal may be a signal that interrupts the power supply line 75. When the charge stop signal is input from the collating ECU 10, the process proceeds to step 910. On the other hand, when no charge stop signal is input from the collating ECU 10, the process proceeds to step 908.

In step 908, it is determined whether the charging operation is completed. For example, when the battery of the mobile terminal is a full charge state or when the mobile terminal is spaced apart from the wireless power supply device 70 (that is, when the mobile terminal is placed at a physically non-chargeable position), it may be determined that the charging operation is completed. When the charging operation is completed, the process ends. When the charging operation is not completed, the process returns to step 906, and the charging operation is continued. In this way, unless the charge stop signal is input to the wireless power supply device 70, the charging operation is continued until the charging operation is completed.

In step 910, the charging operation is stopped. Note that, when the charge stop signal is a signal that interrupts the power supply line 75, the operation of the wireless power supply control unit 72 also stops, so the wireless power supply control unit 72 does not execute the process of step 910. However, in this case, when the power supply line 75 is interrupted, the charging operation is forcibly stopped, so the process of step 910 is substantially executed.

In step 912, it is determined whether the charge resume signal is received. Note that it is possible to generate the charge resume signal in various modes as described above. In addition, the charge resume signal may be input to the wireless power supply device 70 in various modes. For example, the charge resume signal may be input from the collating ECU 10 via a communication line (which may be an exclusive line or may be a communication line, such as a CAN and a LIN). The charge resume signal may be a signal that allows conduction of the power supply line 75. When the charge resume signal is input from the collating ECU 10, the process proceeds to step 904. On the other hand, when no charge resume signal is input from the collating ECU 10, determination of step 912 is carried out again after the predetermined interval.

Here, when the charge resume signal is input, the process may return to step 900, pass through the process of detecting and authenticating a mobile terminal again and then start (resume) the charging operation in step 904. However, desirably, as shown in FIG. 9, the charging operation is started (resumed) directly in step 904. That is, the charging operation is resumed without the process of detecting and authenticating a mobile terminal. This takes into, consideration that a mobile terminal being charged is less likely to be removed within a period of time required for the vehicle interior key collation process (generally, within one second). This suppress execution of the process of detecting and authenticating a mobile terminal each time wireless communication for the vehicle interior key collation process is carried out, so it is possible to reduce a charge stop time of a mobile terminal due to the vehicle interior key collation process. However, in the configuration that the process of detecting and authenticating a mobile terminal is omitted as well, when a period from the time at which the charge stop signal is generated to the time at which the corresponding charge resume signal is generated because of a retry of the key collation process, or the like, the charging operation may be started (resumed) in step 904 after passing through the process of detecting and authenticating a mobile terminal.

Note that, while the charging operation is temporarily stopped, an indication that indicates that the mobile terminal 90 is being charged (for example, a lamp of the mobile terminal 90 is turned on in predetermined color) may be maintained in the mobile terminal 90. By so doing, while the charging operation is temporarily stopped, it is possible to suppress user's misunderstanding that charging is completed (accordingly, the mobile terminal 90 is removed from the wireless power supply device 70 although charging is not completed).

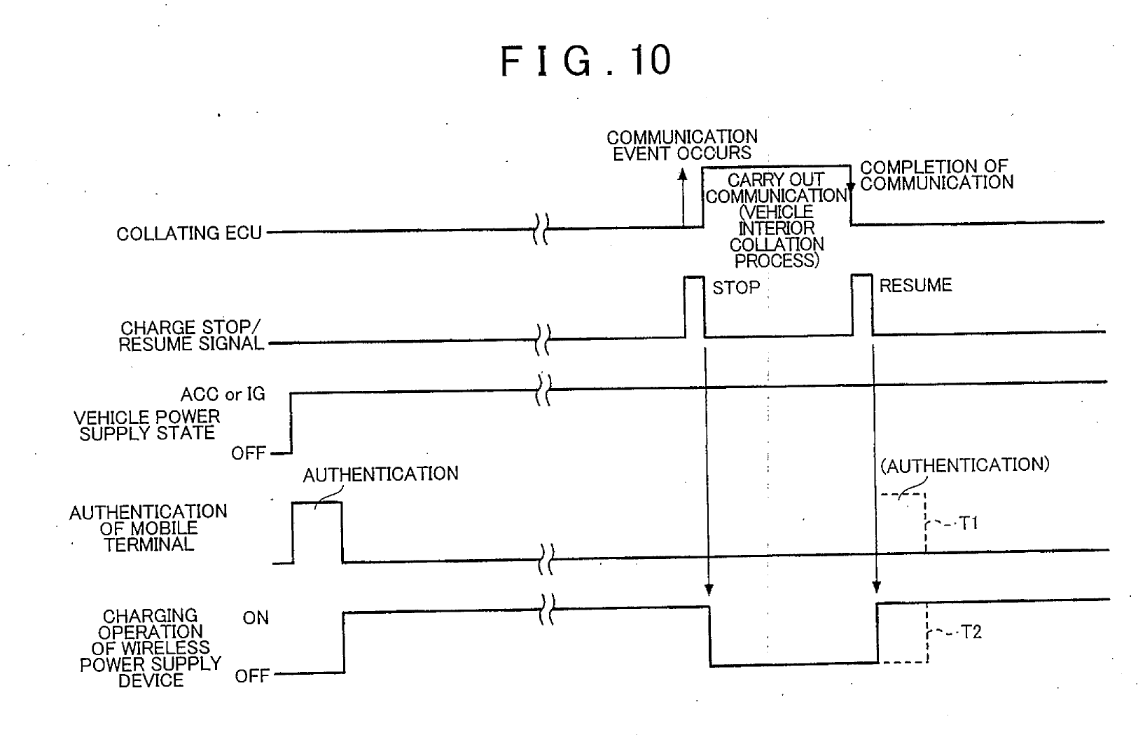

FIG. 10 is a timing chart corresponding to the processes shown in FIG. 9. FIG. 10 shows, from the upper side, the status of the collating ECU 10 (the execution status of the vehicle interior key collation process), the status of the charge stop signal/charge resume signal, a vehicle power supply status, the status of authentication of a mobile terminal, and the status of the charging operation for charging the mobile terminal 90 by the wireless power supply device 70 in time sequence.

As shown in FIG. 10, initially, when the IG or ACC of the vehicle is turned on, the first authentication process for a mobile terminal is executed. After that, when there occurs a communication event, the charge stop signal is generated, and, in response to this, the charging operation for charging the mobile terminal 90 by the wireless power supply device 70 is set to an off state. Then, while the charging operation for charging the mobile terminal 90 by the wireless power supply device 70 is in an off state, communication (vehicle interior key collation process) is carried out. In synchronization with completion of communication, the charge resume signal is generated, and, in response to this, the charging operation for charging the mobile terminal 90 by the wireless power supply device 70 is set to an on state. At this time, if the process of authenticating the mobile terminal is executed again in response to the generation of the charge resume signal as indicated by T1 in FIG. 10, the charging operation for charging the mobile terminal 90 by the wireless power supply device 70 is set to an on state with a delay caused by the execution of the authentication process as indicated by T2 in FIG. 10.

The embodiment of the invention is described above; however, the aspect of the invention is not limited to the above described embodiment. Various modifications and/or replacements may be added to the above described embodiment without departing from the scope of the invention.

For example, in the above described embodiment, the wireless power supply device 70 carries out wireless power supply by utilizing electromagnetic induction; instead, the wireless power supply device may be of another type (for example, magnetic resonance type or electric field type).

In addition, in the above described embodiment, the vehicle interior key collation process is a process to monitor carrying the electronic key 40 outside the vehicle; instead, the purpose of the vehicle interior key collation process may be selected. For example, when a predetermined period has elapsed in a state where the engine remains not started in an ACC state, and when the vehicle interior key collation process for permitting engine start is executed again, the charging operation by the wireless power supply device 70 may be temporarily stopped.

In addition, in the above described embodiment, the charging operation for charging the mobile terminal 90 by the wireless power supply device 70 is stopped from the time when the vehicle interior key collation process is started to the time when the vehicle interior key collation process is completed. However, the timing at which the charging operation for charging the mobile terminal 90 by the wireless power supply device 70 is stopped or resumed may be selectively set within the range in which it is possible to substantially suppress the above-described radio wave interference. For example, the charging operation for charging the mobile terminal 90 by the wireless-power supply device 70 may be desirably stopped before a request signal is transmitted. Thus, for example, the start timing at which the charging operation for charging the mobile terminal 90 by the wireless power supply device 70 is temporarily stopped may be prior to the timing at which the vehicle interior key collation process is started in consideration of a period of time required to stop the charging operation. In addition, when only a request signal is particularly influenced by noise from the wireless power supply device 70, for example, because of a frequency characteristic (that is, when a response signal is not substantially influenced by noise), the charging operation for charging the mobile terminal 90 by the wireless power supply device 70 may be started after a request signal is transmitted and before a response signal is received. In addition, when a radio wave that occurs during the process of detecting and authenticating a mobile terminal, executed at the time of start of charging, influences and becomes noise, the timing at which the charging operation for charging the mobile terminal 90 by the wireless power supply device 70 is resumed may be set in consideration of this.

In addition, in the above described embodiment, in order to suppress inhibition (interference) of the vehicle interior key collation process from a radio wave (noise) emitted from the wireless power supply device 70 during the charging operation, the charging operation of the wireless power supply device 70 is temporarily completely stopped. However, it is also applicable that not the charging operation of the wireless power supply device 70 is temporarily completely stopped but the output level of a radio wave (electric power) transferred for charging is decreased to a level such that the vehicle interior key collation process is not influenced. That is, the charging operation of the wireless power supply device 70 just needs to be suppressed. In this case as well, similar advantageous effects to those of the case where the charging operation of the wireless power supply device 70 is temporarily completely stopped are obtained. Specifically, the charge stop process shown in step 306 of FIG. 3 just needs to be configured as the process of decreasing the output level of a power transfer radio wave. For example, the output level of a power transfer radio wave for charging may be decreased to a level that is equal to or lower than half (50%) of that during normal times. By so doing, charging performance for charging the mobile terminal decreases; however, the charge resume process of step 310 may be implemented as the process of recovering the output level (the process of returning the output level to that during normal times). A period of time during which charging performance is decreased, is temporary, so it does not significantly influence charging of the mobile terminal. At the same time, it is possible to suppress interference during the vehicle interior key collation process.

1. A mobile terminal charging system comprising:
a wireless power supply device that is provided inside a vehicle cabin and that is configured to perform a charging operation for charging a mobile terminal; and
a control device that controls the wireless power supply device, wherein
when wireless communication is carried out between an in-vehicle communication device and an electronic key inside the vehicle cabin in a situation that the charging operation is being performed by the wireless power supply device, the control device temporarily suppresses the charging operation performed by the wireless power supply device.

2. The mobile terminal charging system according to claim 1, wherein the control device temporarily stops the charging operation performed by the wireless power supply device to temporarily suppress the charging operation performed by the wireless power supply device.

3. The mobile terminal charging system according to claim 1, wherein the control device temporarily decreases an output level of electric power transferred for charging to temporarily suppress the charging operation performed by the wireless power supply device.

4. The mobile terminal charging system according to claim 3, wherein the control device temporarily decreases the output level of the transferred electric power to a level at which wireless communication between the in-vehicle communication device and the electronic key inside the vehicle cabin is not influenced.

5. The mobile terminal charging system according to claim 1, wherein the control device temporarily suppresses the charging operation performed by the wireless power supply device by transmitting a charge suppression signal to the wireless power supply device or temporarily interrupting a power supply line from an in-vehicle battery to the wireless power supply device.

6. The mobile terminal charging system according to claim 1, wherein:
a drive signal to an antenna of the in-vehicle communication device is generated at the time when a radio wave from the in-vehicle communication device toward the electronic key is transmitted;
the control device temporarily suppresses the charging operation performed by the wireless power supply device by transmitting a charge suppression signal to the wireless power supply device; and
the control device extracts the drive signal to generate the charge suppression signal.

7. The mobile terminal charging system according to claim 1, wherein:
the wireless power supply device is configured to, when a mobile terminal is placed on the wireless power supply device, execute a process of detecting and authenticating the mobile terminal in advance of the charging operation; and
the wireless power supply device does not execute the process of detecting and authenticating the mobile terminal when the charging operation is resumed after the charging operation is temporarily suppressed.

8. A mobile terminal charging method comprising:
controlling a wireless power supply device, provided inside a vehicle cabin, to perform a charging operation for charging a mobile terminal; and
when wireless communication is carried out between an in-vehicle communication device and an electronic key inside the vehicle cabin in a situation that the charging operation is being performed by the wireless power supply device, temporarily suppressing the charging operation performed by the wireless power supply device.
